(19) United States
(12) Patent Application Publication
(10) Pub. No.: US 2008/0305217 A1
(43) Pub. Date: Dec. 11, 2008

(54) FLAVOR DOTS

(75) Inventor: Michael E. Bowser, Luxemburg, WI (US)

Correspondence Address: Stephen B. Salai, Esq.;Harter, Secrest & Emery LLP, 1600 Bausch & Lomb Place, Rochester, NY, 14604-2711, US

(73) Assignee: WS PACKAGING GROUP, INC., Algoma, WI (US)

(21) Appl. No.: 12/134,101

(22) Filed: Jun. 5, 2008

Related U.S. Application Data
(60) Provisional application No. 60/942,159, filed on Jun. 5, 2007.

(51) Int. Cl. A23G 3/00

(52) U.S. Cl. 426/90

(57) ABSTRACT

An in-line process for packaging flavor pieces includes printing a flavor slurry onto an advancing bottom barrier web in desired shapes and patterns of flavor pieces. A top barrier web is laminated over the printed flavor slurry joining the top and bottom barrier sheets with a series of closed form seals surrounding one or more the flavor pieces. Die cuts through the laminated web separate combinations of the sealed flavor pieces. Gaps in the seals registered with die cuts allow the two barrier webs to be locally separated for accessing the flavor pieces. The bottom barrier web can be affixed to a pressure-sensitive label stock for attaching one or more combinations of sealed flavor pieces to other substrates.

### CROSS REFERENCE TO RELATED APPLICATIONS

This application is a non-provisional of U.S. application Ser. No. 60/942,159, filed Jun. 5, 2007, and is hereby incorporated by reference.

### TECHNICAL FIELD

The invention relates to packages containing edible flavor pieces, such as breath strips, and to manufacturing processes for producing such packages.

### BACKGROUND OF THE INVENTION

Breath and other flavor strips are well known but challenges remain for making and packaging such strip materials in a cost effective manner and for allowing the application of such strip materials to different types of products and product packages. Typical flavor strips are thin, flat, and rectangular in shape and occupy considerable packaging area. The rectangular shape limits how the flavor strips can be packaged or sealed.

Many flavor strip products available in the market today are extruded in a wide web format and slit both longitudinally to narrower widths and transversely to limited lengths in preparation for packaging. The resulting square or rectangular shapes limit the packaging options for this product.

### SUMMARY OF THE INVENTION

The invention in one or more of its preferred embodiments involves printing and packaging flavor pieces, such as flavor or breath mints, in a variety of shapes and sizes, all in one in line process. For example, the flavor or breath mints can be formed as a flavor slurry that is printed onto a film barrier substrate for forming the flavor pieces in a wide variety of shapes at various thicknesses. The various shapes allow the flavor pieces to be applied to a variety of packaging, including packaging where space is limited. The overall process is intended to be efficient with minimal waste.

The flavor slurry can be dispensed in a heated form through a rotary screen or a die extruder. The printed flavor slurry can then be chilled (cured) and sealed in between two barrier materials. Both the application of the flavor slurry and the packaging of the applied slurry can be accomplished in a single or otherwise continuous in-line process. The end product includes single or multiple flavor pieces, such as flavor or breath mints, within a food-safe barrier film package. In addition, the packaged flavor pieces can be produced as a pressure sensitive product, such as for automatic application to another product package, or as non-pressure sensitive product, such as for dropping into another package.

The flavor slurry can be printed or otherwise applied to the barrier material in various thicknesses and shapes and sealed in place within a package that can be further customized for different uses for meeting the packaging needs of customers through an efficient manufacturing process.

### BRIEF DESCRIPTION OF THE DRAWING FIGURES

FIG. 1 is a schematic diagram of an in-line press for printing a succession of flavor dots divided into individual strips.

FIG. 2 is a cross sectional view of the assembled web through one of the flavor dots together with an adjoining section containing surrounding heat seal.

FIG. 3 is a top view of a flavor strip.

FIGS. 4A-4D show alternative flavor strip configurations.

### DETAILED DESCRIPTION OF THE INVENTION

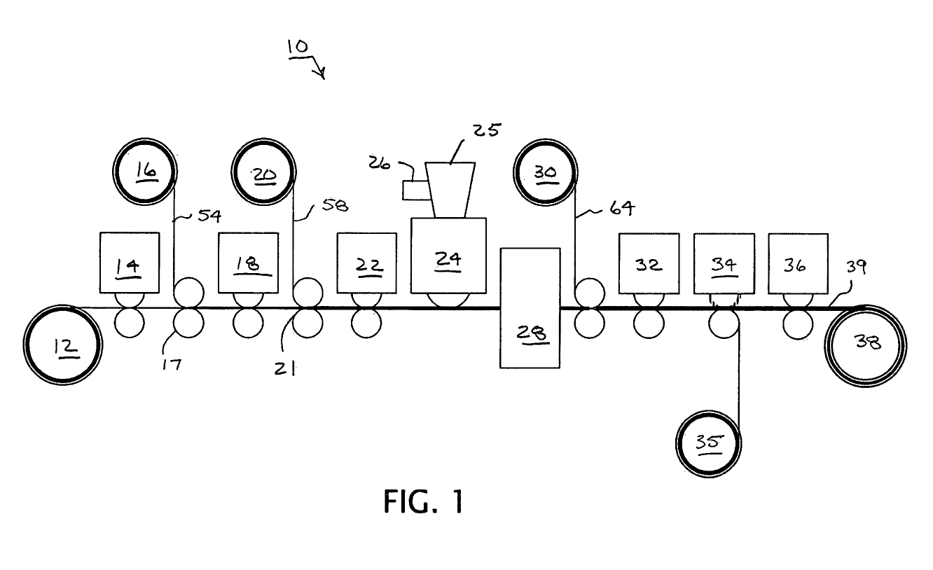

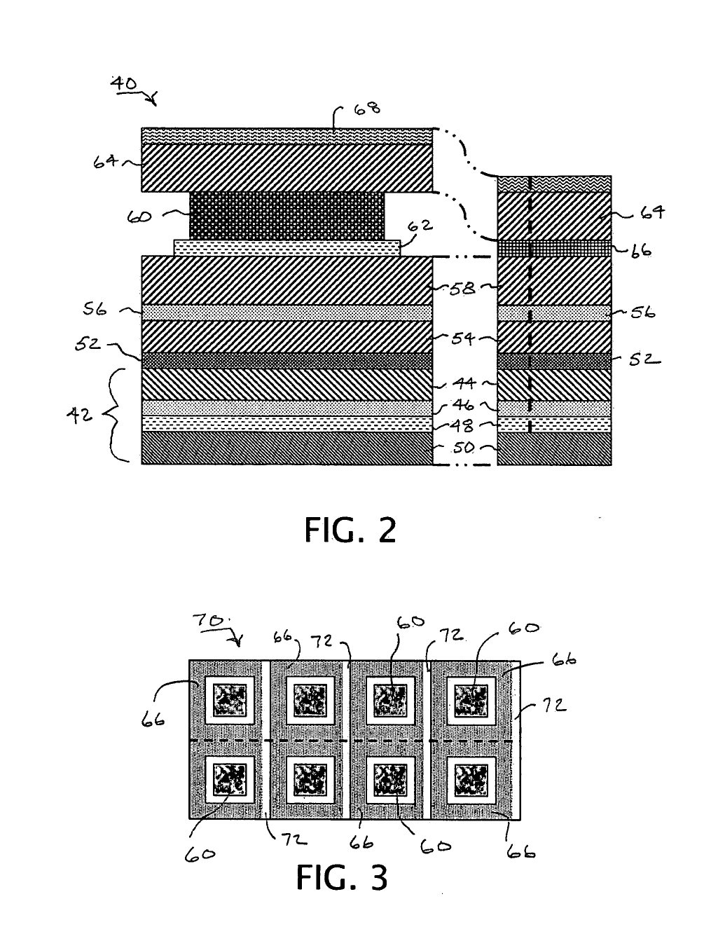

According to one embodiment of the invention as illustrated in FIG. 1, an in-line press 10 is arranged for making a matrix of sealed flavor dots for mounting on product packaging or other substrates. An individual sealed flavor dot assembly 40 as constructed by the press 10 is shown in FIG. 2.

A web of pressure-sensitive label stock 42 is unwound from a roll 12 of the press 10. The pressure-sensitive label stock 42 includes a base sheet 44 backed by a pressure-sensitive adhesive 46 and a liner 50 having a release coating 48 for releasably bonding the base sheet 44 to the liner 50. Both the base sheet 44 and the liner 50 can be made of paper or film, but the base sheet 44 is preferably made as a film such as polypropylene and the liner is preferably made of paper. Although the pressure-sensitive label stock 42 is shown in roll form for supplying the press 10, the individual layers of the pressure-sensitive label stock 42 could be assembled along the press 10.

An applicator station 14 applies a dry-release or “fugitive” adhesive 52 to the base sheet 44 of the web of pressure-sensitive label stock 42, and prior to curing, a web substrate 54, which is also preferably a similar film such as polypropylene is unwound from a roll 16 and laminated at station 17 to the pressure-sensitive label stock 42 to complete a dry-release bond. The dry-residue adhesive 52 provides a clean release (i.e., no tearing and minimal tackiness) upon breaking the adhesive bond and preferably extends throughout all or nearly all of the overlapping space between the base sheet 44 and the web substrate 54. Other dry-release bonds, which are effective between other types of substrates, such as mixtures of adhesive and release, could also be used. Of course, the dry-release adhesive 52 could be applied first to the web substrate 54 and then laminated to the base sheet 44 with similar effect.

An applicator station 18 applies a layer of permanent adhesive 56, which can be a pressure-sensitive adhesive, to the web substrate 54, and a web bottom barrier sheet 58 is unwound from a roll 20 and laminated at station 21 to the web substrate 54. Similar to the dry-release adhesive 52, the permanent adhesive 56 could be applied first to the web bottom barrier sheet 58 and then laminated to the web substrate 54. The web bottom barrier sheet 58 can be a single or multiple ply construction, and is preferably a commercially available poly barrier material in multiple ply format, such as a combination of polypropylene and polyester (PET) films or as a metal foil itself or in combination with a protective film.

A printing station 22 prints a release coating 62 in a matrix pattern on the web bottom barrier sheet 58. The release coating 62 is preferably comprises a release agent approved for contact with food products, including silicone or wax-based agents or agents that contain vegetable oils or other FDA approved ingredients.

A printing station 24 dispenses a heated flavor slurry 250 via a rotary screen or a die extruder onto to the patterned release coating 64 in corresponding array of predetermined shapes. The flavor slurry 25 can be of a type such as disclosed in US Patent Application Publications 2004-0247746 and 2004-0241294, which are hereby incorporated by reference. The rotary screen is preferably made of nickel or other food compatible material with openings of predetermined shape and thickness. In accordance with conventional screen printing practices, a squeegee forces metered amounts of the flavor slurry 25 through the openings and onto the patterned release coating 64. The die extruder, which is preferably made of stainless steel or other food compatible material, incorporates a pump for forcing metered amounts of the flavor slurry 25 through extrusion heads of a desired shape. The extruder can be fashioned from air-eject dies, which are ordinarily used for punching holes in webs.

A heater 26 heats the flavor slurry 25 to a temperature optimum for dispensing by the printing station 24. Temperatures around 260 degrees Fahrenheit are preferred for this purpose. The release coating 62 is formulated to withstand the elevated temperatures of the flavor slurry 25 to assure that the slurry 25 does not permanently adhere to the web bottom barrier sheet 58

A chiller 28 follows the printing station 22 for immediately cooling and solidifying the flavor slurry into flavor dots 60 having the desired shape and thickness. Flavor slurries of other forms can be dried or otherwise cured into the desired solid form.

A web top barrier sheet 64, which can be made of a single or multiple ply material similar to the web bottom barrier sheet 58 is unwound from a roll 30 and directed through a heat-sealing station 32 for joining the web top and bottom barrier sheets 58 and 64 together through a series of closed form seals 66 surrounding the flavor dots 60. However, the heat seals 66 are spaced apart from the flavor dots 60 to provide a surrounding encasement and include one or more unsealed edges so that the top and bottom barrier sheets 58 and 64 can be pealed apart by a customer for breaking the heat-seals and releasing the flavor dots. Other patterned sealing methods could also be used including cold sealed bonds.

A die cut station 34 cuts through one or more of the substrate layers for separating one or more of the printed flavor dots 60 into strips and for individually dispensing the printed flavor dots 60 from the strips as shown for example in FIG. 3, which is described below. A waste winder 35 takes up unused trimming from the die cut station, including a matrix separating groups of the flavor dots 60 into strips, and winds the trimming matrix into a roll for recycling or disposal.

A print station 36 prints text or graphic on the web top barrier sheet 64. The print station 36 can print repetitively, such as web offset, or variably, such as ink jet. Other print stations can be used to print on the opposite surface of the web top barrier sheet 64 or either surface of the bottom barrier sheet 58.

A main winder 38 winds an assembled web 39 of flavor dots 60 into a roll for delivery to an applicator.

As shown in FIG. 3, a strip 70 of flavor dots 60 is shown through a clear top barrier sheet 64. The heat seal 66 is applied in a pattern that surrounds the flavor dots 60 but includes gaps 72 that cooperate with die cut slits 74 and perforations 76 to enable the flavor dots 60 to be individually dispensed. The gaps 72 provide openings for peeling the top barrier sheet 64 apart from the bottom barrier sheet 58 for breaking the heat seal 66 and releasing the flavor dots 60. The release agent allows the flavor piece to be easily removed from the bottom barrier sheet 58 without damaging the flavor dots 60.

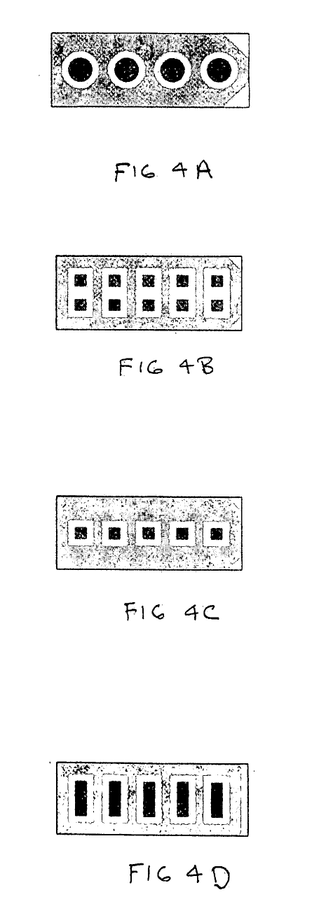

As shown in the accompanying FIGS. 4A-4D, the flavor pieces can be printed as dots, rectangles, squares, or other shapes. The sealed flavor strips can be die-cut to shape, such as for separating combinations of the individual sealed flavor pieces from a web.

The pressure-sensitive versions of the sealed flavor products can be arranged for automatic application to other product packaging. The non-pressure-sensitive versions can also be applied to product packaging using other bonding or attaching techniques or can be captured within the other product packaging, such as by being dropped into the packaging before the other product packaging is sealed.

The flavor products themselves containing not only one or more flavor patterns but also their protective barrier layers can be made in different shapes and sizes for accommodating customer-packaging needs. The barrier layers or other layers, particularly in the form of labels, can be printed with text or graphics that can be related to the flavor pieces captured between the barrier layers or entirely independent thereof. The flavor product can be made as a part of a larger label. Either barrier layer can be clear or opaque and printed with logos or other product related information. For example, the overlying barrier layer can be opaque and printed with product logos or information. Clear layers can be mirror printed from inside surfaces. The interior surfaces of opaque layers can be printed with hidden information (such as for use as a game piece). However, any ink on a barrier surface adjacent to the flavor pieces should be approved for food use.

The flavor pieces can be printed in many different sizes, shapes, and thicknesses as controlled by the printer/applicator, e.g., screen printer. Typical flavor slurries contain mixes of various oils and powders that set in a gelatinous form. For purposes of printing, the gelatinous slurries are mechanically stirred to the desired printing consistency. For example, such screen printable slurries can have a viscosity of around 15,000 centipoises. Screen thickness can be set for printing the slurries to different thicknesses, e.g., 12 to 20 mill. Preferably, the slurries should remain at the required consistency during printing and set only upon application of heat or other curing mechanism.

The ability to convert the flavor product in a single pass through a press allows for printing on the inside of the flavor product films, this offers gaming capabilities in addition to the flavor product. For example, a printed flavor product can contain gaming information on the inside of the barrier films with one or more printed flavor pieces.

1. A method of making a flavor product comprising steps of;
advancing a base barrier layer along a web of an in-line press,
applying a flavor slurry to the base barrier layer, and
laminating an overlying barrier layer for sealing the flavor slurry between the base barrier layer and the overlying barrier layer.
